(19) United States
(12) Patent Application Publication
(10) Pub. No.: US 2026/0089269 A1
(43) Pub. Date: Mar. 26, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YUKARI AKIYAMA, Kanagawa (JP)

(21) Appl. No.: 19/330,054

(22) Filed: Sep. 16, 2025

(30) Foreign Application Priority Data
Sep. 20, 2024 (JP) 2024-164404

(51) Int. Cl. H04N 1/00

(52) U.S. Cl. CPC H04N 1/00018; H04N 1/00074

(57) ABSTRACT

Control is performed to display a screen where image data on a plurality of pages obtained by scanning is displayed as a list, wherein, in a case where a character string is recognized from a previously-designated area in the image data, the recognized character string is displayed in the screen, whereas in a case where a character string is not recognized from the area, an alert is displayed in the screen, wherein, in a display area where image data on a page where an error has occurred in the scanning is displayed, the screen is displayed in a state where a periphery of the image data on the page is colored in a color corresponding to a type of the error, and wherein, in the display area, a plurality of types of errors occurring in the scanning is colored in different corresponding colors.

### BACKGROUND

### Field of the Technology

The present disclosure relates to a screen for displaying image data obtained by scanning.

### Description of the Related Art

There is a technique for setting a character string that is obtained by performing character recognition processing on image data obtained by scanning, as a file name or a folder name, and storing a file including the image data in a folder. Japanese Patent Application Laid-Open No. 2021-005317 describes a technique for, in a case where an error occurs in character recognition processing, displaying image data in which the error has occurred, to notify failure of the character recognition processing.

In the image data obtained by scanning, not only an error in the character recognition processing but also various errors may occur. Examples of the error include document crease and double feeding of documents in scanning. In the technique described in Japanese Patent Application Laid-Open No. 2021-005317, image data on a plurality of pages obtained by scanning is not displayed as a list, and display different for each type of error for facilitating understanding of which type of error occurring in which page among the plurality of pages is not performed.

### SUMMARY

According to embodiments of the present disclosure, a non-transitory computer-readable storage medium stores a computer program for performing a method of controlling an information processing apparatus, and the method includes displaying a screen where image data on a plurality of pages obtained by scanning is displayed as a list, wherein, in a case where a character string is recognized from a previously-designated area in the image data, the recognized character string is displayed in the screen, whereas in a case where a character string is not recognized from the area, an alert is displayed in the screen, wherein, in a display area where image data on a page where an error has occurred in the scanning is displayed, the screen is displayed in a state where a periphery of the image data on the page is colored in a color corresponding to a type of the error, and wherein, in the display area, a plurality of types of errors occurring in the scanning is colored in different corresponding colors.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an entire configuration of a system.

FIG. 2 is a diagram illustrating a hardware configuration of a scanner.

FIG. 3 is a diagram illustrating a hardware configuration of a user terminal.

FIG. 4 is a diagram illustrating a software configuration of the scanner.

FIG. 5 is a diagram illustrating a software configuration of the user terminal.

FIG. 6 is a flowchart illustrating a flowchart of processing in the system.

FIGS. 7A and 7B are diagrams each illustrating an example of a user interface (UI) screen displayed on a user terminal according to a first embodiment.

FIGS. 8A and 8B are diagrams each illustrating an example of a UI screen displayed on a user interface according to a second embodiment.

FIG. 9 is a diagram illustrating an example of profile information held by a data management unit.

FIGS. 10A and 10B are diagrams each illustrating an example of error information held by the data management unit.

### DESCRIPTION OF THE EMBODIMENTS

Some embodiments of the present disclosure are described below with reference to drawings. The following embodiments do not limit the disclosure according to the claims, and all of combinations of features described in the embodiments are not necessarily essential for solving means of the disclosure.

### First Embodiment

### Entire Configuration

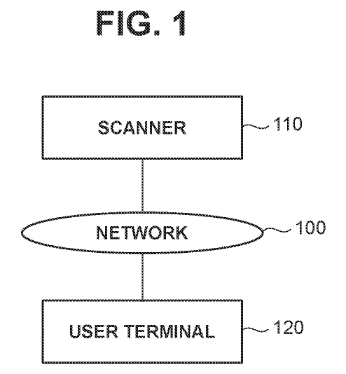

FIG. 1 illustrates examples of a system configuration and a network configuration for implementing the present disclosure.

A network 100 is a network serving as a communication path between apparatuses and is the Internet or an intranet, but is not limited to the Internet or an intranet, and may be a universal serial bus (USB). A communication protocol is not limited to a specific communication protocol, and any of a wired connection and a wireless connection may be used.

A scanner 110 is an apparatus that has a function of reading an image, such as a scanner and a multifunctional peripheral (MFP), and has a function of transferring image data obtained by scanning to an external apparatus.

A user terminal 120 is an information processing apparatus that processes and displays a scan image received through the network 100. More specifically, the user terminal 120 may be a personal computer, a laptop computer, a tablet computer, a smartphone, or the like.

The scanner 110 and the user terminal 120 are communicably connected through the network 100. A plurality of scanners 110 may be connected to the user terminal 120 through the network 100. The system according to the present embodiment has a configuration including the scanner 110 and the user terminal 120, but the configuration of the system is not limited to the example, and the scanner 110 may also have a function of the user terminal 120.

### Hardware Configuration of Scanner

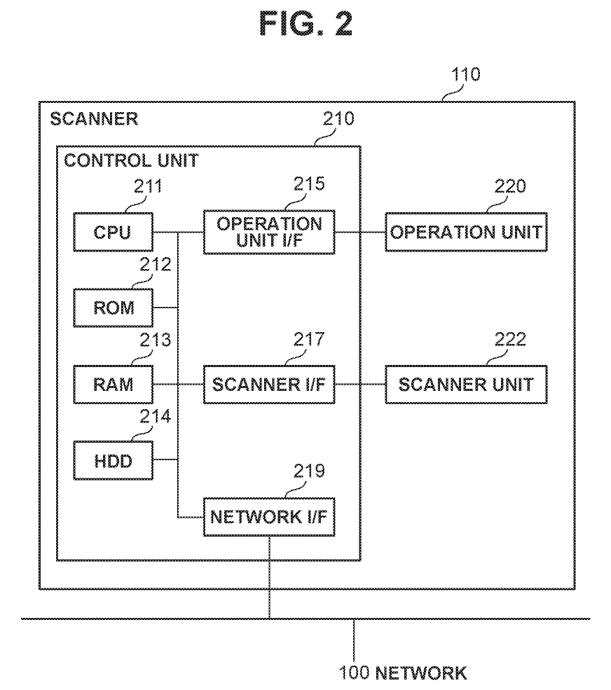

FIG. 2 is a diagram illustrating a hardware configuration of the scanner 110. The scanner 110 includes a control unit 210, an operation unit 220, and a scanner unit 222.

The control unit 210 includes units 211 to 219 described below, and controls entire operation of the scanner 110. A central processing unit (CPU) 211 reads out control programs stored in a read only memory (ROM) 212 and a hard disk drive (HDD) 214, and performs and controls various kinds of functions such as a reading function and a communication function included in the scanner 110. A random access memory (RAM) 213 is used as a temporary storage area such as a main memory and a work area for the CPU 211. In the present embodiment, one CPU 211 performs processing illustrated in a flowchart described below by using one memory (RAM 213 or HDD 214), but the processing is not limited to the example. For example, the processing may be performed by cooperation of a plurality of CPUs and a plurality of RAMs or HDDs. The HDD 214 is a large-capacity storage unit storing image data and various kinds of programs.

An operation unit interface (I/F) 215 is an interface connecting the operation unit 220 and the control unit 210. The operation unit 220 includes a touch panel, a keyboard, and the like, and receives operation, input, and instructions by a user.

A scanner I/F 217 is an interface connecting the scanner unit 222 and the control unit 210. The scanner unit 222 reads a document set on a document platen or an auto document feeder (ADF) (both not illustrated) to generate image data, and inputs the image data to the control unit 210 through the scanner I/F 217. The scanner 110 can transfer the image data generated by the scanner unit 222 to another apparatus through a network I/F 219.

The network I/F 219 is an interface connecting the control unit 210 (scanner 110) to the network 100. The scanner 110 transmits image data to another apparatus on the network 100, and transmits/receives various kinds of information to/from another apparatus on the network 100, by using the network I/F 219.

### Hardware Configuration of User Interface

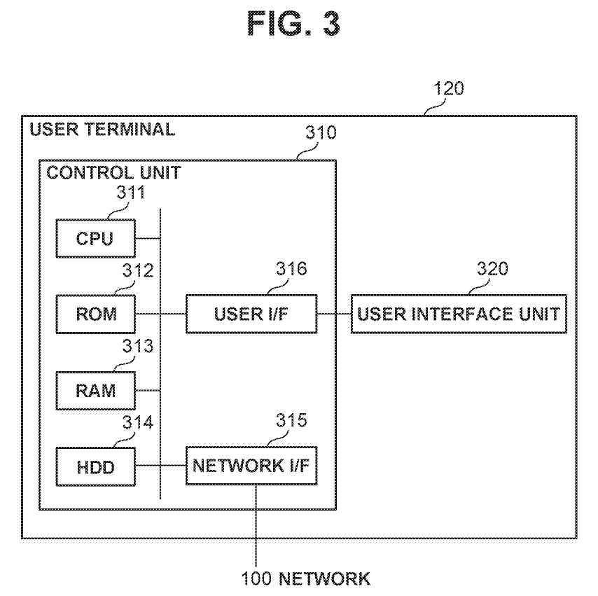

FIG. 3 is a diagram illustrating a hardware configuration of the user terminal 120. The user terminal 120 includes a control unit 310 and a user interface unit 320.

The control unit 310 includes a CPU 311, a ROM 312, a RAM 313, an HDD 314, a user I/F 316, and a network I/F 315. The CPU 311 reads out control programs stored in the ROM 312, and performs various kinds of processing to control entire operation. The RAM 313 is used as a temporary storage area such as a main memory and a work area for the CPU 311. The HDD 314 is a large-capacity storage unit storing image data and various kinds of programs. The network I/F 315 is an interface connecting the user terminal 120 to the network 100. The user terminal 120 receives image data from another apparatus such as the scanner 110, and transmits/receives various kinds of information to/from another apparatus, through the network I/F 315.

The user interface unit 320 performs input/output of information and signals through a display, a keyboard, a mouse, buttons, a touch panel, and the like. A computer not including the hardware can be connected and operated from another computer through a remote desktop, a remote shell, or the like.

### Software Configuration of Scanner

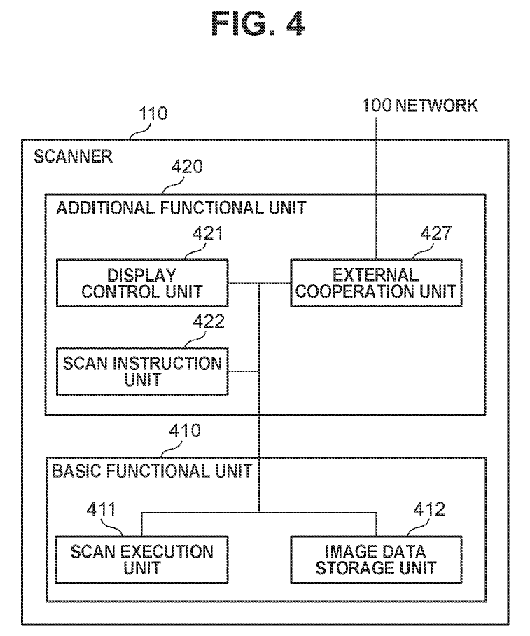

FIG. 4 is a diagram illustrating a software configuration of the scanner according to the present embodiment.

The scanner 110 includes a basic functional unit 410 and an additional functional unit 420. When the CPU 211 reads out programs stored in the ROM 212 and the HDD 214 of the control unit 210 to the RAM 213 and executes the programs, the functional units are realized.

Units included in the basic functional unit 410 are standardly provided in the scanner 110, whereas the additional functional unit 420 is an application additionally installed in the scanner 110. Note that another additional application (not illustrated) may be installed in the scanner 110.

The basic functional unit 410 includes a scan execution unit 411 and an image data storage unit 412.

The additional functional unit 420 includes a display control unit 421, a scan instruction unit 422, and an external cooperation unit 427.

The display control unit 421 displays a user interface (UI) screen for receiving operation by the user on a liquid display unit including a touch panel function of the operation unit 220 of the scanner 110. The display control unit 421 displays an operation screen for receiving, for example, operation for scan setting and scan start, and operation for preview of a scanned image, output setting of a scanned image, and output start of a scanned image.

The scan instruction unit 422 requests the scan execution unit 411 to perform scan processing corresponding to scan setting input through the UI screen of the display control unit 421.

The scan execution unit 411 receives a scan request including the scan setting from the scan instruction unit 422 or the external cooperation unit 427. In response to the scan request, the scan execution unit 411 generates scan image data by reading a document with the scanner unit 222 through the scanner I/F 217. The generated scan image data is transmitted to the image data storage unit 412. The scan execution unit 411 transmits an image identifier for uniquely identifying the stored scan image data, to the scan instruction unit 422 or the external cooperation unit 427. The image identifier is a number, a symbol, an alphabet, or the like (not illustrated) for uniquely identifying an image scanned by the scanner 110, and the like.

The image data storage unit 412 stores the scan image data received from the scan execution unit 411 in the HDD 214.

The external cooperation unit 427 transmits a scan request including scan setting received from the user terminal 120, to the scan instruction unit 422, and transmits image data obtained by scan processing to the user terminal 120.

### Software Configuration of User Terminal

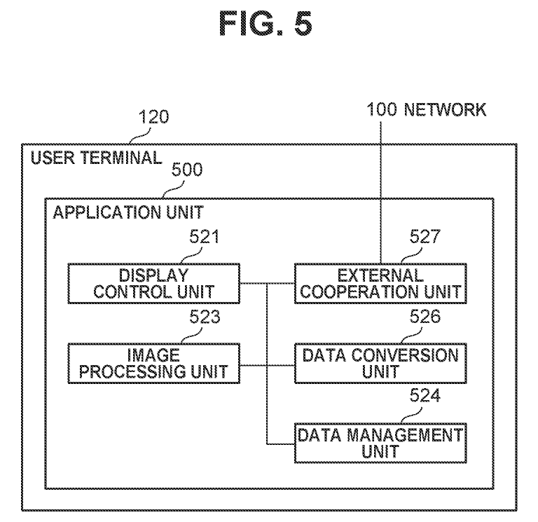

FIG. 5 is a diagram illustrating a software configuration of the user terminal according to the present embodiment. The user terminal 120 includes an application unit 500. The application unit 500 includes a display control unit 521, an image processing unit 523, a data management unit 524, a data conversion unit 526, and an external cooperation unit 527.

The display control unit 521 displays a UI screen for receiving operation by the user on a display unit of the user interface unit 320 of the user terminal 120. The display control unit 521 displays an operation screen for receiving, for example, operation for scan setting and scan start, and operation for preview of a scanned image, output setting of a scanned image, and output start of a scanned image.

The image processing unit 523 performs analysis processing and modification processing on the scan image. The image processing unit 523 performs various kinds of processing on the mage, for example, character area analysis in the image data acquired from the HDD 314, optical character recognition (OCR), barcode area analysis, image rotation and inclination correction, and generation of a thumbnail image.

The data management unit 524 holds profile information such as coordinates designated as a character recognition area, a character string, a file name, a folder name, and a storage destination, in association with the image identifier. Further, the data management unit 524 stores the coordinates designated as the character recognition area, the file name, the folder name, and the storage destination as preset profile information in the HDD 314. Furthermore, the data management unit 524 holds a page number where an error has been detected and an error type in association with each other. Furthermore, the data management unit 524 determines presence/absence of the preset profile information.

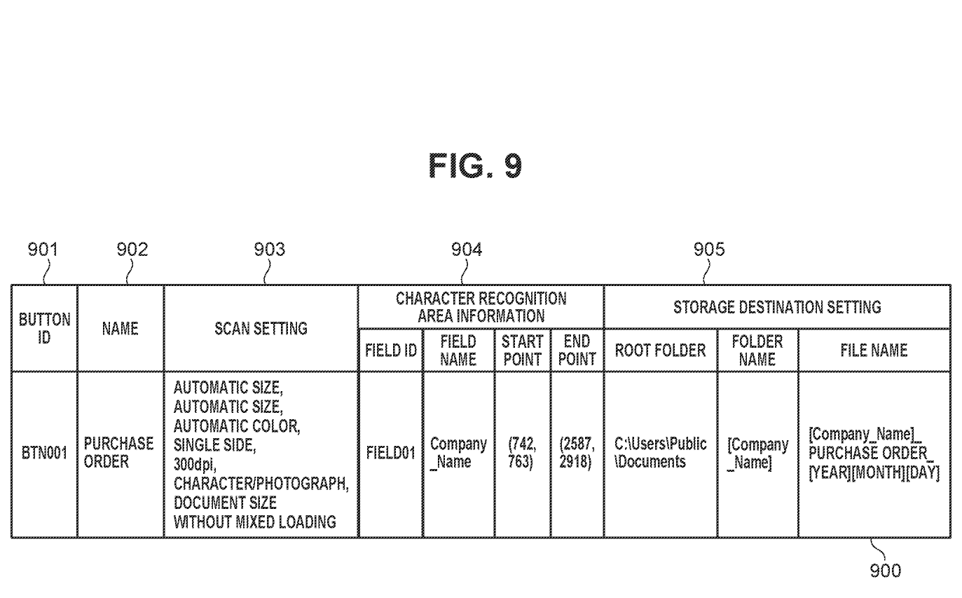

FIG. 9 illustrates an example of the profile information held by the data management unit 524. FIG. 9 illustrates a profile information management table 900, a button identifier (ID) for identifying a profile button 901, a profile name 902 input by the user in step S604, an example 903 in which default scan setting is input as an initial value, and setting of a sheet size, a color, a resolution, and the like is stored, character recognition area information 904 set in step S604, where a field ID, a field name, and a start point and an end point of the character recognition area are stored, and information on storage destination setting of scan image data 905, where a root folder, a naming rule of the folder name, and a naming rule of the file name are stored. [Company_Name] described in columns of the folder name and the file name means usage of a character string extracted based on the character recognition area information having the field ID of FIELD01. In addition, as [year][month][day], a character string obtained by connecting information on a current date by underscores is generated.

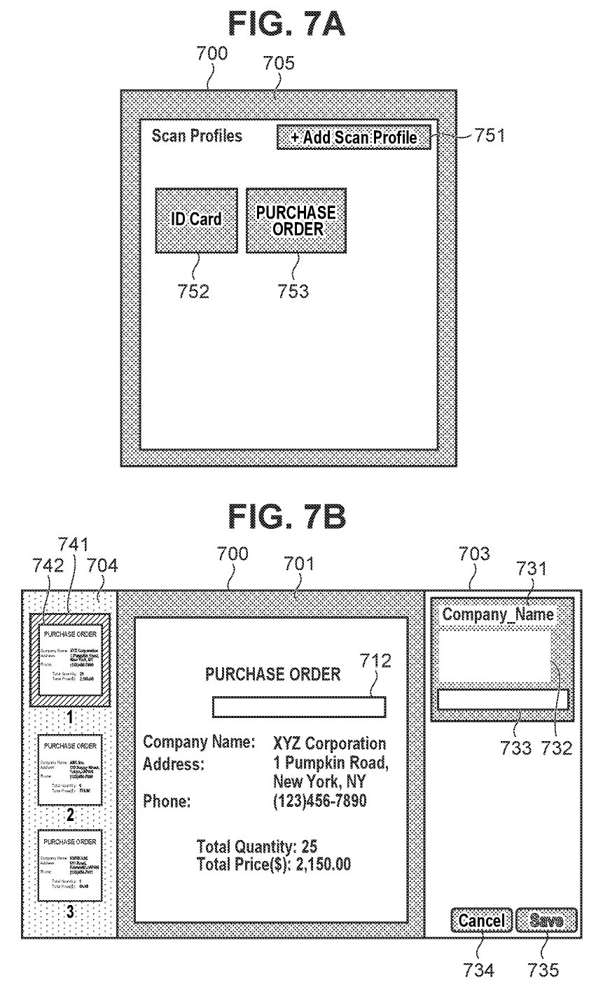

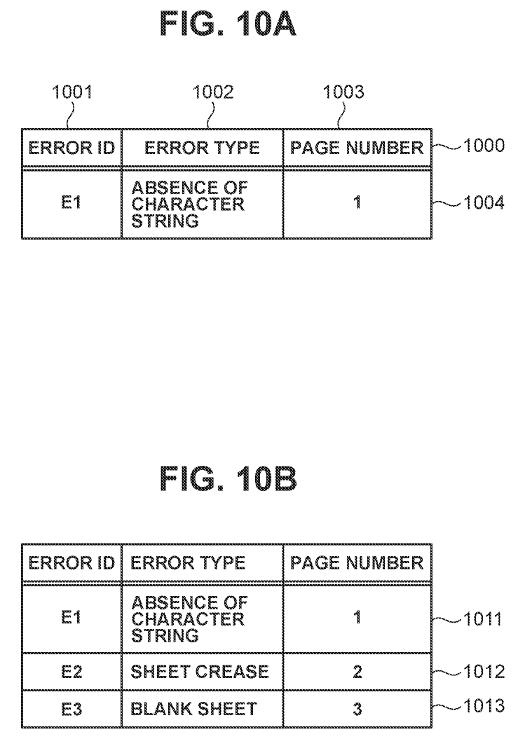

FIGS. 10A and 10B each illustrate an example of the error information held by the data management unit 524. FIG. 10A illustrates an example in a case where one error has occurred. The error information illustrated in FIG. 10A is associated with display of a UI screen illustrated in FIG. 7B, and is used to display an alert on a thumbnail image in step S613.

FIG. 10A illustrates a table 1000 for managing the error information, an ID 1001 for identifying an error a column 1002 for storing an error type, a column 1003 for storing a page number where an error has occurred, and an example 1004 of the error information, where an example in which information indicating that an error of "absence of character string" has occurred in a first page of a scan image is stored in an error ID of E1 is illustrated.

FIG. 10A illustrates the example of the error information in a case where a character string is not detected in the character recognition processing. However, the error occurring during execution of scanning is not limited to an error of recognition failure in the character recognition processing. An error, for example, double feeding of sheets, sheet crease, and a blank sheet may be detected. There is an issue that an error is difficult to be recognized in a case where such an error has occurred. In such a case, as described below, the thumbnail image is highlighted in a different color corresponding to the error type, which facilitates recognition of the error.

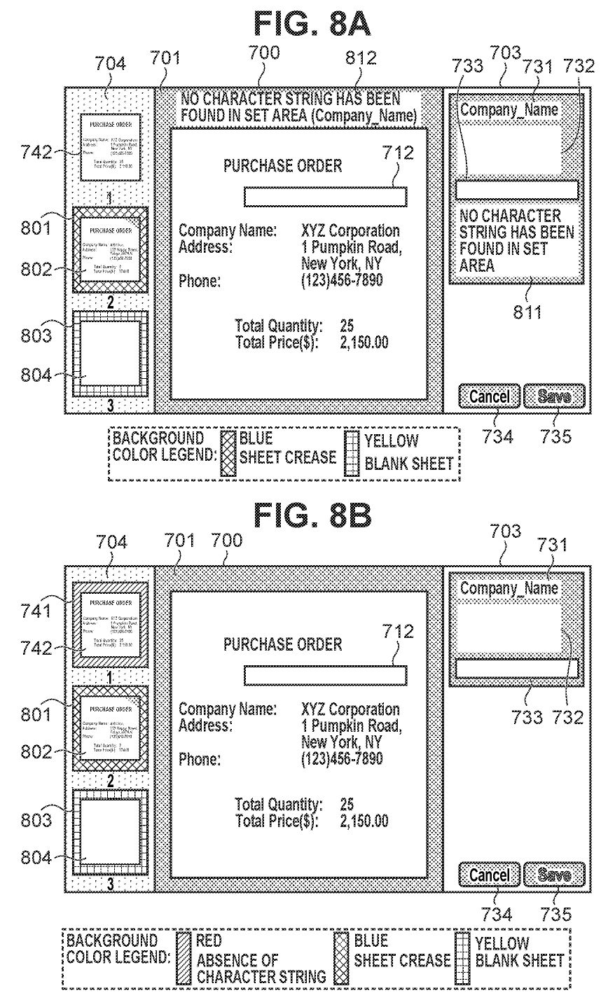

FIG. 10B is a diagram illustrating an example of the error information held by the data management unit 524 in a case where a plurality of types of errors has occurred. FIG. 10B is associated with display of UI screens illustrated in FIGS. 8A and 8B, and is used to display an error on a thumbnail image in step S613.

In FIG. 8A, in a case of an error of a type of "absence of character string", an alert is issued in a form of a message indicating that a character string has not been recognized from a preset area. FIG. 8Aillustrates the messages 811 and 812. The message 811 is displayed in association with an area 733 described below. The message 812 is displayed above image data displayed in a preview panel 701 described below. In FIG. 8A, both the messages 811 and 812 are displayed, but display is not limited to the example. Any one of the messages 811 and 812 may be displayed.

An error of a type of "sheet crease" and an error of a type of "blank sheet" are color-coded based on "background color legend" for a thumbnail image, described at a lower part in FIG. 8A. More specifically, blue is associated with an error of a type of "sheet crease", and yellow is associated with an error of a type of "blank sheet".

FIG. 11B illustrates an example 1011 of the error information, where an example in which information indicating that an error of "absence of character string" has occurred in a first page of a scan image is stored in the error ID of E1 is illustrated. In step S613, based on the E1 error information, the display control unit 521 displays at least one of the messages 811 and 812.

FIG. 11B illustrates an example 1012 of the error information, where an example in which information indicating that an error of "sheet crease" has occurred in a second page of the scan image is stored in an error ID of E2 is illustrated. In step S613, based on the E2 error information, the display control unit 521 displays an alert in blue for a second page 801.

FIG. 11B illustrates an example 1013 of the error information, where an example in which information indicating that an error of "blank sheet" has occurred in a third page of the scan image is stored in an error ID of E3 is illustrated. In step S613, based on the E3 error information, the display control unit 521 displays an alert in yellow for a third page 803.

In FIG. 8B, the error of the type of "sheet crease" and the error of the type of "blank sheet" are handled in a manner similar to FIG. 8A. The error of the type of "absence of character string" is color-coded based on "background color legend" for a thumbnail image described at a lower part in FIG. 8B. More specifically, red is associated with the error of the type of "absence of character string".

In the case illustrated in FIG. 8B, the display control unit 521 displays an alert in red for a first page 741 based on the E1 error information. Note that at least one of the messages 811 and 812 may be displayed while an alert for the first page 741 is displayed as illustrated in FIG. 8B.

The data conversion unit 526 acquires an image corresponding to the image identifier received from the image processing unit 523, from the HDD 314, and converts the image into a file format corresponding to the output setting input through the UI screen of the user interface unit 320. The data conversion unit 526 acquires a file name corresponding to the image identifier received from the image processing unit 523, from the data management unit 524, and sets the file name as a file name of the converted file. The data conversion unit 526 transmits the converted file and the corresponding image identifier to the HDD 314, and the data management unit 524 holds the received file in association with the image identifier.

The external cooperation unit 527 provides a function of enabling the scanner 110 and the user terminal 120 to operate in cooperation with each other. The external cooperation unit 527 transmits a scan execution processing request including information on the scan setting to the scanner 110 and receives the scan image data from the scanner 110, in response to an instruction received from the user interface unit 320 of the user terminal 120.

The scan image data received from the scanner 110 is stored in the HDD 314 of the user terminal 120.

### Entire Flow of Processing

In the processing described below, the CPU 311 of the user terminal 120 reads out the control programs stored in the ROM 312 and the HDD 314, and performs and controls various kinds of functions and functions of applications held by the user terminal 120.

During the processing by the user terminal 120, the CPU 211 of the scanner 110 reads out the control programs stored in the ROM 212 and the HDD 214 in response to an instruction from the user terminal 120. Further, the CPU 211 of the scanner 110 performs and controls various kinds of functions held by the scanner 110 and functions of applications.

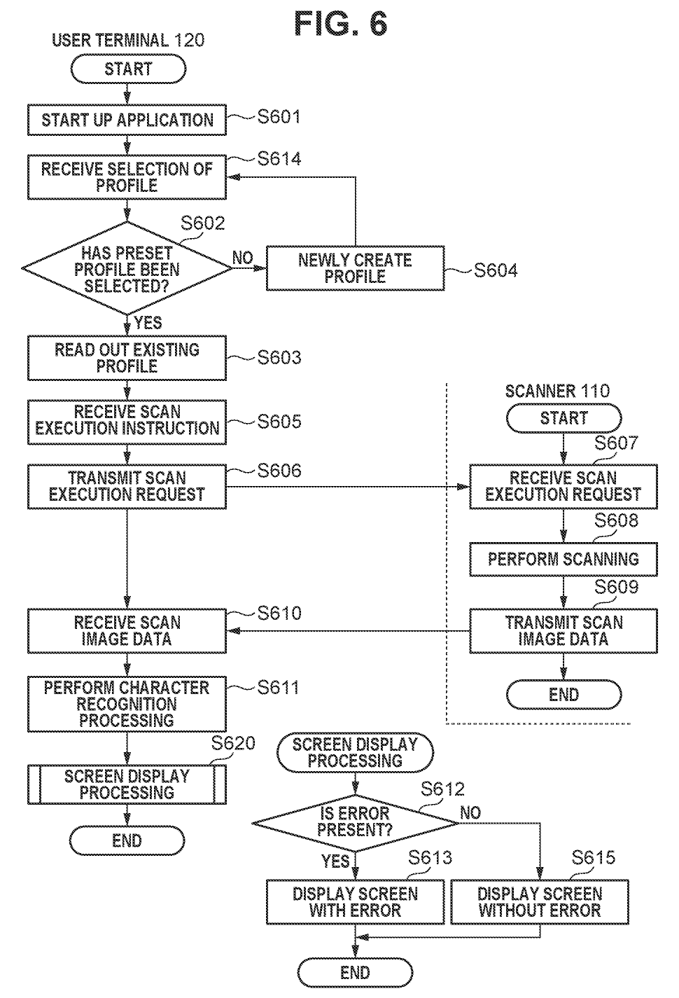

FIG. 6 is a flowchart illustrating a flow of processing for displaying an alert when an error occurs from the image data scanned by the scanner 110. An alert is displayed for a plurality of types of errors. For example, the plurality of types of errors may include a type of "absence of character string", namely, a type in which a character string is not recognized from a previously-designated area subjected to the character recognition processing. The plurality of types of errors may further include a type of "sheet crease", namely, a type in which a document to be scanned is folded in scanning. The plurality of types of errors may further include a type of "blank sheet", namely, a type in which a document to be scanned is a blank sheet. Further, although not illustrated in FIGS. 10A and 10B, the plurality of types of errors may further include a type of "double feeding", namely, a type in which a document to be scanned is overlapped with another document.

An application (hereinafter, referred to as scan application) that displays an alert in a case where a character recognition error is detected from the scan image data according to the present embodiment becomes usable when the application is installed in the user terminal 120.

The user interface unit 320 of the user terminal 120 displays a screen (not illustrated) in which an icon, a menu, an executable file, and the like for executing the application provided by the user terminal 120 are displayed.

FIG. 7A is a diagram illustrating an example of a screen of the scan application displayed by the display control unit 521 of the application unit 500, and is used to select and newly create a scan profile. FIG. 7A illustrates a main panel 700 of the scan application.

FIG. 7B, FIG. 8A, and FIG. 8B each illustrate an example of the screen of the scan application displayed by the display control unit 521 of the application unit 500. The screen is a screen for displaying image data on a plurality of pages obtained by scanning, as a list. In the screen, a list of the plurality of pages is displayed in a thumbnail panel 704. Among the plurality of pages, one page designated by the user is displayed in a preview panel 701. FIG. 7B is a diagram illustrating a state where an alert is displayed in a case where an error in which a character string cannot be extracted occurs as a result of character recognition. FIG. 8A and FIG. 8B each illustrate an example in which, even in a case where errors other than the error in the character recognition processing are detected, an alert is displayed with a periphery of each thumbnail image being highlighted in a corresponding color.

Information about alert display is acquired from the error information illustrated in FIG. 10B held by the data management unit 524.

When detecting a scan application execution instruction such as click of the icon, the menu, or the executable file in the scan application, the user interface unit 320 of the user terminal 120 starts the flow illustrated in FIG. 6. In step S601, the user terminal 120 starts up the scan application by reading out and executing a program of the scan application. Subsequent processing is performed by the application unit 500 of the user terminal 120. When the scan application is started up, the display control unit 521 displays the main panel 700 as an initial screen of the scan application.

In step S614 after the scan application is started up, the user terminal 120 displays a scan profile panel 705 illustrated in FIG. 7A in order to receive a user instruction either to select a preset profile of scan setting or newly create a profile. In the scan profile panel 705, profile buttons 752 and 753 for reading out existing preset setting, and a profile creation button 751 for newly creating a profile are displayed. The profile is a function of storing setting values of scan setting set once, an area to be subjected to character recognition, file storage information, and the like in the HDD 314 of the user terminal 120, and reusing the setting values. A plurality of different combinations of setting values can be stored so as to be recognizable by a profile name.

The display control unit 521 of the user terminal 120 detects that any button has been pressed in the scan profile panel 705. Then, in step S602, the data management unit 524 of the user terminal 120 determines whether the preset profile has been selected by the user.

In a case where the user has selected the profile button 752 or 753 for reading out the existing preset setting, it is determined to use the preset profile (YES in step S602), and the processing proceeds to step S603.

In contrast, in a case where the user has selected the profile creation button 751 for newly creating a profile, it is determined not to use the preset profile (NO in step S602), and the processing proceeds to step S604.

In a case where it is determined in step S602 that the profile for reading out the existing preset setting has been selected, the processing proceeds to step S603, and the data management unit 524 reads out the setting values of the selected profile from the HDD 314. The existing profile is previously created in step S604 described below. The selected profile is identified by the button ID associated with the profile button, and the setting values stored in association with the button ID are used in the subsequent processing. The button ID is an ID generated by the data management unit 524 when a profile is created, and is a number, a symbol, an alphabet, or the like (not illustrated) for uniquely identifying registered setting values.

In a case where it is determined in step S602 that the preset profile is not used, the processing proceeds to step S604, and the display control unit 521 receives input of a "profile name" in a popup screen (not illustrated) in order to newly create a profile. Further, the display control unit 521 receives operation for designating an area to be subjected to character recognition processing through a UI screen (not illustrated), and associates a field name for identifying designated area information with the button ID.

In addition, after information on the output destination of the file is set, the profile name, the scan setting, the field name, the storage destination setting, and the like are stored in the data management unit 524 in association with the button ID created for the new profile. The processing then returns to step S614.

When selection of the profile is received in step S603, the processing proceeds to step S605. In step S605, a message for prompting the user to place a document to be scanned on a document platen or the ADF is displayed (not illustrated). When a button for instructing execution of scanning (not illustrated) is pressed, a scan execution instruction is received.

When the display control unit 521 receives the scan execution instruction in step S605, the processing proceeds to step S606. In step S606, the external cooperation unit 527 transmits a scan execution processing request including information on the scan setting to the scanner 110.

In step S607, the external cooperation unit 427 of the scanner 110 receives the scan execution processing request transmitted in step S606. The external cooperation unit 427 transmits the scan execution processing request received from the user terminal 120, to the scan execution unit 411.

In step S608, the scan execution unit 411 of the scanner 110 scans the sheet placed on the document platen or the ADF, and stores acquired scan image data in the image data storage unit 412.

In step S609, the external cooperation unit 427 transmits the scan image data stored in the image data storage unit 412, to the external cooperation unit 527 of the user terminal 120.

In step S610, the external cooperation unit 527 of the user terminal 120 receives the scan image data transmitted from the scanner 110, and stores the scan image data in the HDD 314 of the user terminal 120.

In step S611, the image processing unit 523 of the user terminal 120 reads out the scan image data from the HDD 314, and performs the character recognition processing on the scan image data. The character recognition processing is performed on a rectangular area represented by the character recognition area information 904 in the profile information management table 900 acquired through the data management unit 524.

In step S620, the display control unit 521 performs screen display processing for the main panel 700 of the scan application based on a character recognition result. Whether there is an error is determined from the character recognition result in step S611. In a case where there is an error, the display control unit 521 displays a thumbnail image with an error on the thumbnail panel 704, whereas in a case where there is no error, the display control unit 521 displays a thumbnail image without an error on the thumbnail panel 704.

In step S612, the image processing unit 523 of the user terminal 120 determines whether there is an error indicating whether a character string has been acquired in the character recognition processing performed in step S611. In a case where it is determined that there is an error, a page number where the error has been detected, and an error type are associated with each other and are stored in the data management unit 524.

In a case where it is determined in step S612 that there is an error (YES in step S612), the display control unit 521 of the user terminal 120 displays a screen illustrated in FIG. 7B, FIG. 8A, or FIG. 8B in step S613. FIG. 7B illustrates the preview panel 701 for displaying a preview screen of the scan image.

The display control unit 512 displays a rectangular area 712 used in the character recognition processing so as to overlap with the preview screen on the preview panel 701. In this case, an example is illustrated in which a character string of "XYZ Corporation" is expected to be detected in the character recognition processing but the character string is deviated from a previously-designated coordinate position due to any factor.

The display control unit 512 displays a field panel 703 for displaying a character recognition result for each character recognition area. The following areas are disposed in the field panel 703. A first area is a field name display area 731 where a field name is displayed. A second area is a character recognition image display area 732 where an image of a target area subjected to the character recognition processing is displayed. A third area is an area 733 for displaying a character string extracted as a result of the character recognition processing.

In the example illustrated in FIG. 7B, since the character string is deviated from the previously-designated coordinate position due to any factor, an error in which a character string cannot be acquired in the character recognition processing occurs.

For this reason, in the example illustrated in FIG. 7B, no image is displayed on the character recognition image display area 732, and no character string is displayed in the area 733. Further, a button 735 for storing an image of the scan result and a button 734 for canceling the processing are displayed. When the button 735 is pressed, the scan image is stored in the storage destination designated by the storage destination setting 905 in the profile information management table 900, and the processing returns to step S614. In a case where the button 734 is pressed, the processing returns to step S614 without storing the scan image.

The thumbnail panel 704 is a thumbnail panel for displaying a thumbnail image created by the image processing unit 523 and an error. The display control unit 521 displays thumbnail images of the scan image data page by page as a list in the thumbnail panel 704. A thumbnail image 742 is a thumbnail image of the scan image currently displayed in the preview panel 701. The thumbnail image is created by the image processing unit 523.

The display control unit 521 checks presence/absence of error information stored in the data management unit 524, and acquires the error information illustrated in FIG. 10A and FIG. 10B. In the error information 1000, as an error having the error ID of E1, the page number where the error has occurred, and the error type are stored. In the error information illustrated in FIG. 10B, as errors having error IDs of E1, E2, and E3, the page number where the error has occurred, and the error type are stored.

The example illustrated in FIG. 7B is an example in a case where error information indicating that no character string is detected in a first page is present. The display control unit 521 displays the error with the periphery of the thumbnail image of the first page 741 being highlighted in a color. In other words, in a display area where the image data on the page where the error has occurred is displayed, the screen in a state where the periphery of the image data on the corresponding page is colored is displayed. A hatched area as the periphery of the thumbnail image of the first page means that the hatched area is colored.

As a result, since the first page of the scan image is colored, the user easily recognizes occurrence of the error in which the character string cannot be acquired, by viewing the thumbnail list displayed in the thumbnail panel 704.

FIGS. 8A and 8B each illustrate the example in which, even in the case where an error other than the error in the character recognition processing is detected, an alert is displayed with the periphery of the thumbnail image being highlighted in a color. Details are as described above.

Note that, as illustrated in FIG. 8A, an alert for the error information on the type of "absence of character string" may be displayed in a form of at least one of the messages 811 and 812.

In the above-described manner, when an error other than the error in the character recognition processing, such as double feeding, sheet crease, and blank sheet occurs, the error can be easily recognized in the screen where the scan image obtained by scanning by the scanner is displayed page by page, which improves convenience.

In the present embodiment, the screen in the state where the periphery of the page where the error has occurred is colored is displayed. This may be realized in such a manner that the display control unit 521 displays the screen in a state where a back surface of the image data on the page where the error has occurred is colored, in the display area where the image data on the corresponding page is displayed.

In a case where it is determined in step S612 that there is no error (NO in step S612), the display control unit 521 displays a thumbnail image without an error in the thumbnail panel 704 in step S615. In this case, a character string of "XYZ Corporation" is included in the rectangular area 712 used in the character recognition processing in the preview panel 701 (not illustrated). Further, an image of "XYZ Corporation" is displayed in the character recognition image display area 732 in the field panel 703, and a character string of "XYZ Corporation" is displayed in the area 733 for displaying an extracted character string (not illustrated).

As described above, in the screen where the scan image obtained by scanning by the scanner is displayed page by page, failure in acquisition of a character string by the character recognition processing can be easily recognized, which improves convenience.

### Other Embodiments

The present disclosure can be realized by supplying a program realizing one or more functions of the above-described embodiment to a system or an apparatus through a network or a storage medium, and causing one or more processors in a computer of the system or the apparatus to read out and execute the program. Further, the present disclosure can be realized by a circuit (e.g., application specific integrated circuit (ASIC) or field programmable gate array (FPGA)) realizing one or more functions.

The application according to the present embodiment can provide a mechanism that displays a screen for facilitating understanding of occurrence of which type of error in image data in which page among the image data on the plurality of pages obtained by scanning.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-164404, filed September 20, 2024, which is hereby incorporated by reference herein in its entirety.

What is claimed is:

1. A non-transitory computer-readable storage medium that stores a computer program for performing a method of controlling an information processing apparatus, the method comprising:
displaying a screen where image data on a plurality of pages obtained by scanning is displayed as a list,
wherein, in a case where a character string is recognized from a previously-designated area in the image data, the recognized character string is displayed in the screen, whereas in a case where a character string is not recognized from the area, an alert is displayed in the screen,
wherein, in a display area where image data on a page where an error has occurred in the scanning is displayed, the screen is displayed in a state where a periphery of the image data on the page is colored in a color corresponding to a type of the error, and
wherein, in the display area, a plurality of types of errors occurring in the scanning is colored in different corresponding colors.

2. The non-transitory computer-readable storage medium according to claim 1, wherein the alert is a message indicating that a character string is not recognized from the previously-designated area.

3. The non-transitory computer-readable storage medium according to claim 2,
wherein, in the case where a character string is recognized from the previously-designated area in the image data, the recognized character string is displayed in a field displayed on the screen, and
wherein, in the case where a character string is not recognized from the area, the alert is displayed in association with the field.

4. The non-transitory computer-readable storage medium according to claim 1,
wherein the plurality of types of errors includes an error of a type in which a character string is not recognized from the previously-designated area, and
wherein the alert is displayed by coloring a periphery of image data on a page including the previously-designated area, in a color corresponding to the type of error.

5. The non-transitory computer-readable storage medium according to claim 1, wherein the plurality of types of errors includes an error of a type in which a document to be scanned in the scanning is folded.

6. The non-transitory computer-readable storage medium according to claim 1, wherein the plurality of types of errors includes an error of a type in which a document to be scanned in the scanning is overlapped with another document.

7. The non-transitory computer-readable storage medium according to claim 1, wherein the plurality of types of errors includes an error of a type in which a document to be scanned in the scanning is a blank sheet.

8. An information processing apparatus comprising:
a display unit configured to display a screen where image data on a plurality of pages obtained by scanning is displayed as a list,
wherein, in a case where a character string is recognized from a previously-designated area in the image data, the recognized character string is displayed in the screen, whereas in a case where a character string is not recognized from the area, an alert is displayed in the screen,
wherein, in a display area where image data on a page where an error has occurred in the scanning is displayed, the screen is displayed in a state where a periphery of the image data on the page is colored in a color corresponding to a type of the error, and
wherein, in the display area, a plurality of types of errors occurring in the scanning is colored in different corresponding colors.

9. A method of controlling an information processing apparatus, the method comprising:
displaying a screen where image data on a plurality of pages obtained by scanning is displayed as a list,
wherein, in a case where a character string is recognized from a previously-designated area in the image data, the recognized character string is displayed in the screen, whereas in a case where a character string is not recognized from the area, an alert is displayed in the screen,
wherein, in a display area where image data on a page where an error has occurred in the scanning is displayed, the screen is displayed in a state where a periphery of the image data on the page is colored in a color corresponding to a type of the error, and
wherein, in the display area, a plurality of types of errors occurring in the scanning is colored in different corresponding colors.
